(19) United States
(12) Patent Application Publication
(10) Pub. No.: US 2015/0163813 A1
(43) Pub. Date: Jun. 11, 2015

(54) BANDWIDTH CONTROL METHOD, DEVICE, AND SYSTEM

(71) Applicant: Huawei Technologies Co., Ltd., Shenzhen (CN)

(72) Inventors: Aiqin ZHANG, Shenzhen (CN); Weisheng JIN, Shenzhen (CN)

(21) Appl. No.: 14/624,127

(22) Filed: Feb. 17, 2015

Related U.S. Application Data
(63) Continuation of application No. PCT/CN2012/080875, filed on Aug. 31, 2012.

(51) Int. Cl. H04W 72/04

(52) U.S. Cl. CPC H04W 72/0493

(57) ABSTRACT

Embodiments of the present invention provide a bandwidth control method, a bandwidth control device, and a bandwidth control system. The method includes: receiving, by a PCEF entity or a BBERF entity, a downlink shared bandwidth value of one or multiple sub data flows transmitted by a PCRF entity; and performing bandwidth control to downlink data flows of the one or multiple sub data flows according to the downlink shared bandwidth value. Embodiments of the present invention can perform associated bandwidth control to one or multiple sub data flows in the downlink direction, such that downlink data flows of the one or multiple sub data flows make full use of the shared bandwidth, thereby solving a problem that the existing bandwidth control mechanism hinders efficient use of the bandwidth.

### CROSS REFERENCE TO RELATED APPLICATIONS

This application is a continuation of International Patent Application No. PCT/CN2012/080875, filed on Aug. 31, 2012, which is hereby incorporated by reference in its entirety.

### TECHNICAL FIELD

Embodiments of the present invention relate to the field of wireless communication technologies and, in particular, to a bandwidth control method, a bandwidth control device, and a bandwidth control system.

### BACKGROUND

There are abundant service applications in the mobile network, such as QQ, Skype and Facebook. While sub-application types corresponding to actual media types or media application modes of these popular applications are diversified, for instance, for the QQ-based application, there are sub-applications such as QQ online video service (QQ Video), QQ file download (QQ file) and QQ speech transmission (QQ Speech), and quality of service (QoS for short) requirements of these sub-applications are different, since in a long term evolution (LTE for short) system and a universal mobile telecommunications system (UMTS for short), dividing of transmission quality of different data flows is implemented via a bearer, such as an evolved packet system (EPS for short) bearer and a UTMS bearer, thus sub data flows corresponding to different sub-applications in the same application may be mapped to different bearers.

Under a current mechanism, bandwidth of an application is limited by policy and charging control (PCC for short) rules. As described above, since the sub-applications of QQ, such as QQ Speech, QQ file and QQ Video, have different QoS requirements, thus it needs to construct the PCC rules having different quality of service class identifiers (QCI for short) and/or allocation and retention priorities (ARP for short), respectively. Therefore, overall bandwidth limit of the QQ applications needs to be achieved by performing bandwidth control to each sub data flow. For instance, the overall bandwidth limit of 2M bits/second (bit/s, bps for short) of the QQ applications is assigned to each sub data flow, where QQ Speech has a bandwidth limit of 0.5M bps, QQ file has a bandwidth limit of 0.5M bps, and QQ Video has a bandwidth limit of 1M bps.

Although operators' initial requirement lies in enabling all sub data flows under a specific application to share a bandwidth with a certain threshold assigned to the application, the current PCC rules-based bandwidth control mechanism makes the bandwidth of sub data flows corresponding to a certain sub-application (such as QQ Speech) could never reach an upper limit (for instance, 2M bps) of the overall bandwidth of this application, even in a case that other sub-applications (such as QQ Video, QQ file) do not have any data flow. As a matter of fact, it can be seen that the existing separation control hinders efficient use of the bandwidth, and is not in compliance with intentions of the operators for the overall bandwidth limit of a certain kind of application or a certain type of application group.

### SUMMARY

Embodiments of the present invention provide a bandwidth control method, a bandwidth control device and a bandwidth control system, which are used to solve a problem that the existing bandwidth control mechanism hinders efficient use of the bandwidth.

In a first aspect, embodiments of the present invention provide a bandwidth control method, including:

receiving, by a policy and charging enforcement function PCEF entity or a bearing binding and event report function BBERF entity, a downlink shared bandwidth value of one or multiple sub data flows transmitted by a policy and charging rules function PCRF entity; and

performing bandwidth control to downlink data flows of the one or multiple sub data flows according to the downlink shared bandwidth value.

In a second aspect, embodiments of the present invention provide a bandwidth control method, including:

determining, by a policy and charging rules function PCRF entity, a downlink shared bandwidth value of one or multiple sub data flows; and

transmitting the downlink shared bandwidth value to a policy and charging enforcement function PCEF entity or a bearing binding and event report function BBERF entity, so that the PCEF entity or the BBERF entity performs bandwidth control to downlink data flows of the one or multiple sub data flows according to the downlink shared bandwidth value.

In a third aspect, embodiments of the present invention provide a bandwidth control method, including:

receiving, by a terminal, an uplink shared bandwidth value of one or multiple sub data flows transmitted by a mobility management entity MME or a radio network controller RNC or transmitted by an application server; and

performing bandwidth control to uplink data flows of the one or multiple sub data flows according to the uplink shared bandwidth value.

In a fourth aspect, embodiments of the present invention provide a bandwidth control method, including:

determining, by a policy and charging rules function PCRF entity, an uplink shared bandwidth value of one or multiple sub data flows; and

transmitting the uplink shared bandwidth value of the one or multiple sub data flows to a terminal via a mobility management entity MME or a radio network controller RNC, to enable the terminal to perform bandwidth control to uplink data flows of the one or multiple sub data flows according to the uplink shared bandwidth value.

In a fifth aspect, embodiments of the present invention provide a bandwidth control device, which is applied in a policy and charging enforcement function PCEF entity or a bearing binding and event report function BBERF entity, including:

a receiving module, configured to receive a downlink shared bandwidth value of one or multiple sub data flows transmitted by a policy and charging rules function PCRF entity; and

a bandwidth control module, configured to perform bandwidth control to downlink data flows of the one or multiple sub data flows according to the downlink shared bandwidth value.

In a sixth aspect, embodiments of the present invention provide a bandwidth control device, which is applied in a policy and charging rules function PCRF entity, including:

a determining module, configured to determine a downlink shared bandwidth value of one or multiple sub data flows; and

a transmitting module, configured to transmit the downlink shared bandwidth value to a policy and charging enforcement function PCEF entity or a bearing binding and event report function BBERF entity, to enable the PCEF entity or the BBERF entity to perform bandwidth control to downlink data flows of the one or multiple sub data flows according to the downlink shared bandwidth value.

In a seventh aspect, embodiments of the present invention provide a bandwidth control device, which is applied in a terminal, including:

a receiving module, configured to receive an uplink shared bandwidth value of one or multiple sub data flows transmitted by a mobility management entity MME or a radio network controller RNC or transmitted by an application server; and

a bandwidth control module, configured to perform bandwidth control to uplink data flows of the one or multiple sub data flows according to the uplink shared bandwidth value.

In an eighth aspect, embodiments of the present invention provide a bandwidth control device, which is applied in a policy and charging rules function PCRF entity, including:

a determining module, configured to determine an uplink shared bandwidth value of one or multiple sub data flows; and

a transmitting module, configured to transmit the uplink shared bandwidth value of the one or multiple sub data flows to a terminal via a mobility management entity MME or a radio network controller RNC, to enable the terminal to perform bandwidth control to uplink data flows of the one or multiple sub data flows according to the uplink shared bandwidth value.

In a ninth aspect, embodiments of the present invention provide a bandwidth control system, including: a policy and charging rules function PCRF entity, and a policy and charging enforcement function PCEF entity or a bearing binding and event report function BBERF entity;

the PCRF entity includes a bandwidth control device according to the sixth aspect;

the PCEF entity or the BBERF entity includes a bandwidth control device according to the fifth aspect.

In a tenth aspect, embodiments of the present invention provide a bandwidth control system, including: a policy and charging rules function PCRF entity, a terminal, and a mobility management entity MME or a radio network controller RNC;

the PCRF entity includes a bandwidth control device according to the eighth aspect;

the terminal includes a bandwidth control device according to the seventh aspect.

In an eleventh aspect, embodiments of the present invention provide a bandwidth control device, which is applied in a policy and charging enforcement function PCEF entity or a bearing binding and event report function BBERF entity, including:

a receiver, configured to receive a downlink shared bandwidth value of one or multiple sub data flows transmitted by a policy and charging rules function PCRF entity; and

a processor, configured to perform bandwidth control to downlink data flows of the one or multiple sub data flows according to the downlink shared bandwidth value.

In a twelfth aspect, embodiments of the present invention provide a bandwidth control device, which is applied in a policy and charging rules function PCRF entity, including:

a processor, configured to determine a downlink shared bandwidth value of one or multiple sub data flows; and

a transmitter, configured to transmit the downlink shared bandwidth value to a policy and charging enforcement function PCEF entity or a bearing binding and event report function BBERF entity, to enable the PCEF entity or the BBERF entity to perform bandwidth control to downlink data flows of the one or multiple sub data flows according to the downlink shared bandwidth value.

In a thirteenth aspect, embodiments of the present invention provide a bandwidth control device, which is applied in a terminal, including:

a receiver, configured to receive an uplink shared bandwidth value of one or multiple sub data flows transmitted by a mobility management entity MME or a radio network controller RNC or transmitted by an application server; and

a processor, configured to perform bandwidth control to uplink data flows of the one or multiple sub data flows according to the uplink shared bandwidth value.

In a fourteenth aspect, embodiments of the present invention provide a bandwidth control device, which is applied in a policy and charging rules function PCRF entity, including:

a processor, configured to determine an uplink shared bandwidth value of one or multiple sub data flows; and

a transmitter, configured to transmit the uplink shared bandwidth value of the one or multiple sub data flows to a terminal via a mobility management entity MME or a radio network controller RNC, to enable the terminal to perform bandwidth control to uplink data flows of the one or multiple sub data flows according to the uplink shared bandwidth value.

In a fifteenth aspect, embodiments of the present invention provide a bandwidth control system, including: a policy and charging rules function PCRF entity, a policy and charging enforcement function PCEF entity or a bearing binding and event report function BBERF entity;

the PCRF entity includes a bandwidth control device according to the twelfth aspect;

the PCEF entity or the BBERF entity includes a bandwidth control device according to the eleventh aspect.

In a sixteenth aspect, embodiments of the present invention provide a bandwidth control system, including: a policy and charging rules function PCRF entity, a terminal, and a mobility management entity MME or a radio network controller RNC;

the PCRF entity includes a bandwidth control device according to the fourteenth aspect;

the terminal includes a bandwidth control device according to the thirteenth aspect.

At least one technical solution of the technical solutions above has the following advantages or beneficial effects:

embodiments of the present invention can perform associated bandwidth control to downlink data flows of one or multiple sub data flows by using the technical means of receiving a downlink shared bandwidth value of one or multiple sub data flows transmitted by a PCRF entity and performing bandwidth control to the downlink data flows of the one or multiple sub data flows according to the downlink shared bandwidth value by a PCEF entity or a BBERF entity, such that the downlink data flows of the one or multiple sub data flows make full use of the shared bandwidth, thereby solving a problem that the existing bandwidth control mechanism hinders efficient use of the bandwidth.

### BRIEF DESCRIPTION OF DRAWINGS

In order to make technical solutions in embodiments of the present invention or the prior art more clearly, accompanying drawings used in the description of embodiments of the present invention or the prior art will be briefly described hereunder. Obviously, the described drawings are merely some embodiments of present invention. For persons of ordinary skill in the art, other drawings may be obtained based on these drawings without any inventive effort.

FIG. 1 is a schematic flow chart of a bandwidth control method according to an embodiment of the present invention;

FIG. 2 is a schematic flow chart of a bandwidth control method according to another embodiment of the present invention;

FIG. 3 is a schematic flow chart of a bandwidth control method according to still another embodiment of the present invention;

FIG. 4 is a schematic flow chart of a bandwidth control method according to still another embodiment of the present invention;

FIG. 5 is a schematic diagram of a signaling according to the embodiments as shown in FIG. 3 and FIG. 4;

FIG. 6 is a schematic diagram of another signaling according to the embodiments as shown in FIG. 3 and FIG. 4;

FIG. 7 is a schematic structural diagram of a bandwidth control device 700 according to an embodiment of the present invention;

FIG. 8 is a schematic structural diagram of a bandwidth control device 800 according to another embodiment of the present invention;

FIG. 9 is a schematic structural diagram of a bandwidth control system 900 according to an embodiment of the present invention;

FIG. 10 is a schematic structural diagram of a bandwidth control device 1000 according to another embodiment of the present invention;

FIG. 11 is a schematic structural diagram of a bandwidth control device 1100 according to another embodiment of the present invention;

FIG. 12 is a schematic structural diagram of a bandwidth control system 1200 according to another embodiment of the present invention;

FIG. 13 is a schematic structural diagram of a bandwidth control device 1300 according to still another embodiment of the present invention;

FIG. 14 is a schematic structural diagram of a bandwidth control device 1400 according to still another embodiment of the present invention;

FIG. 15 is a schematic structural diagram of a bandwidth control device 1500 according to still another embodiment of the present invention;

FIG. 16 is a schematic structural diagram of a bandwidth control device 1600 according to still another embodiment of the present invention;

FIG. 17 is a schematic structural diagram of a bandwidth control system 1700 according to still another embodiment of the present invention;

FIG. 18 is a schematic structural diagram of a bandwidth control system 1800 according to still another embodiment of the present invention.

### DESCRIPTION OF EMBODIMENTS

In order to make objectives, technical solutions, and advantages of embodiments of the present invention more clear, the technical solutions in embodiments of the present invention are hereinafter described clearly and completely with reference to accompanying drawings in embodiments of the present invention. Obviously, the described embodiments are only a part of embodiments of the present invention, rather than all embodiments of the present invention. All other embodiments obtained by persons of ordinary skill in the art based on embodiments of the present invention without any inventive effort shall fall within the protection scope of the present invention.

FIG. 1 is a schematic flow chart of a bandwidth control method according to an embodiment of the present invention. As shown in FIG. 1, the method includes:

101, receiving, by a policy and charging enforcement function (PCEF for short) entity or a bearing binding and event report function (BBERF for short) entity, a downlink shared bandwidth value of one or multiple sub data flows transmitted by a policy and charging rules function (PCRF for short) entity.

In an LTE scenario, the PCEF entity is generally located in a packet data network (PDN for short) gateway (GW for short), and the BBERF entity is generally located in a serving gateway (SGW for short); in a 3G scenario, the PCEF entity is generally located in a gateway GPRS support node (GGSN for short), and the BBERF entity is generally located in a serving GPRS support node (SGSN for short).

Specifically, the PCRF entity may decide to perform various QoS control functions on a traffic detection function (TDF for short) entity, the PCEF entity or the BBERF entity, for example, closing data flow (gating), bandwidth control (shaping), redirection (redirection) and etc. For instance, the PCRF entity decides that the functions of closing data flow (gating) and bandwidth control (shaping) are performed by the PCEF entity or the BBERF entity, and that the function of redirection (redirection) is performed by the TDF entity, where, instructing the PCEF entity to perform the functions of closing data flow (gating) and bandwidth control (shaping) by the PCRF entity may be implemented via a PCC rule on a Gx interface, and the instructing the BBERF entity to perform the functions of closing data flow (gating) and bandwidth control (shaping) by the PCRF entity may be implemented via a PCC rule on a Gxx interface.

Generally, if the PDN GW and the SGW abide by a GPRS tunneling protocol (GTP for short), then in 101, the PCEF entity receives the downlink shared bandwidth value issued by the PCRF entity via a Gx interface, optionally, also receives a PCC rule issued by the PCRF entity via the Gx interface. Specifically, the downlink shared bandwidth value and/or the PCC rule may be carried in an IP connectivity access network (IP-CAN for short) session (session) modification message.

If the PDN GW and the SGW abide by a proxy mobile IP (PMIP for short) protocol, then the BBERF entity receives the downlink shared bandwidth value issued by the PCRF entity via a Gxx interface, optionally, also receives a QoS rule issued by the PCRF entity via the Gxx interface. Specifically, the downlink shared bandwidth value and/or the QoS rule may be carried in a gateway control session modification message.

Specifically, each sub data flow corresponds to a sub application. Herein, one or multiple sub data flows correspond to one or multiple sub applications, the one or the multiple sub applications may belong to a same application, and may also belong to different applications.

102, performing bandwidth control to downlink data flows of the one or multiple sub data flows according to the downlink shared bandwidth value.

Specifically, the performing the bandwidth control to the downlink data flows of the one or multiple sub data flows according to the downlink shared bandwidth value may be controlling total bandwidth of the downlink data flows of the one or multiple sub data flows within a range of the downlink shared bandwidth value. For instance, the one or multiple sub data flows include QQ Video sub data flows and QQ Speech sub data flows, the downlink shared bandwidth value is 2M bps, then control total bandwidth of downlink data flows of the QQ Video sub data flows and the QQ Speech sub data flows not to exceed 2M bps.

After 102, the method also includes: performing a corresponding PCC rule or QoS rule to the downlink data flow of each sub data flow. Specifically, according to the PCC rule or the QoS rule corresponding to each sub data flow, bind the downlink data flow of each data flow to which the bandwidth control has been performed to a corresponding bearer.

In further, the downlink shared bandwidth value in 101 may be transmitted to the PCEF entity or the BBERF entity in different forms and by being carried in different carriers by the PCRF entity.

In an optional embodiment of the present invention, 101 specifically includes:

receiving an associated control rule transmitted by the PCRF entity, where the associated control rule includes flow description of the one or multiple sub data flows and the downlink shared bandwidth value;

correspondingly, 102 specifically includes:

acquiring the flow description and the downlink shared bandwidth value from the associated control rule; and

performing the bandwidth control to the downlink data flows of the one or multiple sub data flows corresponding to the flow description according to the downlink shared bandwidth value.

Generally, the flow description of a sub data flow include an application identifier (Application ID) of an application to which the sub data flow belongs and description information of the sub data flow, where, the description information may include a source address, a destination address, a port number, etc. One application may include multiple sub applications, and each sub application corresponds to one sub data flow. Specifically, one application identifier may identify one application, and may also identify one application group, where, one application group may include multiple applications, and may also include all or a part of sub applications which belong to one or multiple applications. Specifically, it may be agreed upon by a network side and a terminal in advance each application identification corresponds to which application or which application group. For instance, a part of sub applications of A application and a part of sub applications of B application may be divided into one application group, and identified with one application identifier.

In this scenario, preferably, the one or multiple sub data flows are all sub data flows corresponding to one or multiple application identifiers. It should be noted that, the bandwidth limit performed to a certain application or a certain type of application group by the PCEF entity is within a range of an IP connectivity access network (IP-CAN for short) session, and may be a treatment crossing different IP-CAN bearers.

Specifically, the associated control rule may include a rule identifier, description information of a data flow, and bandwidth information. The rule identifier is unique in the IP-CAN session, and an application identifier corresponding to a data flow may be used as the rule identifier; the description information of the data flow may be detected from a TDF entity, and may also come from an application function (AF for short) entity, a proxy-call session control function (P-CSCF for short) entity or other application servers such as an application server of Skype applications; the bandwidth information represents a bandwidth limit of the data flow corresponding to the description information of the data flow, and is used to indicate the downlink shared bandwidth value, e.g., 2M bps.

Similar to the flow description of the sub data flow, flow description of a data flow usually includes an application identifier of an application to which the data flow belongs and description information of the data flow, where, the description information may include a source address, a destination address, a port number, etc. The data flow corresponding to an application identifier includes all sub data flows corresponding to the application identifier, thus, the description information in the flow descriptions of the data flow corresponding to an application identifier covers description information of all sub data flows corresponding to the application identifier. For instance, a QQ application identifier corresponds to a QQ application, a data flow of the QQ application includes QQ video sub data flows, QQ Speech sub data flows and QQ file sub data flows, the port number corresponding to the QQ video sub data flows is 1, the port number corresponding to the QQ Speech sub data flows is 2, and the port number corresponding to the QQ file sub data flows is 3, then port numbers in the description information of the flow descriptions of the data flow corresponding to the QQ application identifier include 1-3.

In another optional embodiment of the present invention, 101 specifically includes:

receiving, by the PCEF entity, enhanced PCC rules of each sub data flow in the one or multiple sub data flows transmitted by the PCRF entity, or receiving, by the BBERF entity, enhanced QoS rules of each sub data flow in the one or multiple sub data flows transmitted by the PCRF entity, where the enhanced PCC rule of each sub data flow includes a PCC rule corresponding to the sub data flow and a monitoring key for shared bandwidth, and the enhanced QoS rule of each sub data flow includes a QoS rule corresponding to the sub data flow and a monitoring key for shared bandwidth;

102 specifically includes:

determining a downlink shared bandwidth value corresponding to the monitoring key for shared bandwidth; and

performing the bandwidth control according to the downlink shared bandwidth value to the downlink data flows of one or multiple sub data flows of which the enhanced PCC rule or the enhanced QoS rule includes the monitoring key for shared bandwidth.

One of the functions of an existing single PCC rule lies in mapping one or multiple sub data flows having a same QCI and ARP value to a certain bearer. Thus, when different sub data flows (QQ video, QQ speech, QQ file) in the QQ application have different QCI and/or ARP requirements, different PCC rules need to be used to describe these sub data flows (QQ video, QQ speech, QQ file) separately. In order to better implement associated bandwidth control performed by the PCEF entity or the BBERF entity to sub data flows coming from different PCC rules, in embodiments of the present invention, a PCC rule of a sub data flow to which the associated bandwidth control needs to be performed is marked to form an enhanced PCC rule, specifically, a monitoring key for shared bandwidth is added in the original PCC rule, this monitoring key may be generated by the PCRF entity or acquired by the PCRF entity from other entities such as a home subscriber server (HSS for short) or a subscriber profile repository (SPR for short). The PCRF entity uses this monitoring key to mark the sub data flow that needs bandwidth sharing, where this mark is transferred in all PCC rules corresponding to sub data flows that need to be associated. Certainly, the PCRF entity may also use different monitoring keys for bandwidth to mark different groups of sub data flows which need the bandwidth sharing respectively. The QoS rules are similar.

In further, there may be many ways for determining the downlink shared bandwidth value corresponding to the monitoring key for shared bandwidth.

Optionally, the enhanced PCC rule or the enhanced QoS rule of at least one sub data flow in the one or multiple sub data flows also include the downlink shared bandwidth value;

the determining the downlink shared bandwidth value corresponding to the monitoring key for shared bandwidth specifically includes:

determining a downlink shared bandwidth value included in filter description of the at least one sub data flow as a downlink shared bandwidth value corresponding to the monitoring key for shared bandwidth included in the enhanced PCC rule or the enhanced QoS rule of the at least one sub data flow.

Specifically, the downlink shared bandwidth value is also newly added in the enhanced PCC rule or the enhanced QoS rule. Since the downlink shared bandwidth value is shared by one or multiple sub data flows, thus, as long as the downlink shared bandwidth value is carried in the enhanced PCC rule or the enhanced QoS rule of one of the sub data flows, it will be OK, while unnecessary to carry the downlink shared bandwidth value in the enhanced PCC rule or the enhanced QoS rule of each sub data flow. It should be noted that, in order to adapt to unceasing changes of a network policy, a time stamp may also be newly added in the enhanced PCC rule or the enhanced QoS rule, when downlink shared bandwidth values corresponding to a same monitoring key included in the enhanced PCC rules or the enhanced QoS rules of one or multiple sub data flows are different, then the one with the latest time stamp prevails.

Optionally, before 101, the method also includes:

receiving a first key-bandwidth correlation table transmitted by the PCRF entity, where the first key-bandwidth correlation table includes a corresponding relation between the monitoring key for shared bandwidth and the downlink shared bandwidth value;

the determining the downlink shared bandwidth value corresponding to the monitoring key for shared bandwidth specifically includes:

determining the downlink shared bandwidth value corresponding to the monitoring key for shared bandwidth according to the first key-bandwidth correlation table.

Specifically, during a process of establishing or modifying an IP-CAN session, the PCRF entity transmits the first key-bandwidth correlation table to the PCEF entity, for instance: a monitoring key “key 1” corresponds to 2 Mbps, a monitoring key “key 2” corresponds to 4 Mbps, a monitoring key “key 3” corresponds to 6 Mbps, etc. Thus, in the enhanced PCC rule, only a monitoring key “key X” needs to be added, and the PCEF entity finds a downlink shared bandwidth value corresponding to key X in the first key-bandwidth correlation table, for instance, a monitoring key “key 2” is included in the enhanced PCC rule, then the PCEF entity determines that the corresponding downlink shared bandwidth value is 4 Mbps.

Optionally, the first key-bandwidth correlation table may also be predefined. For instance, it is predefined that key 2.0 represents that a downlink shared bandwidth value is 2.0 Mbps, and key 200 represents that a downlink shared bandwidth value is 200 Mbps.

In general, the monitoring key for shared bandwidth in embodiments of the present invention has two roles: the first is to associate sub data flows identified by multiple enhanced PCC rules or multiple enhanced QoS rules together, and the second is to define a downlink shared bandwidth value of the associated sub data flows.

Embodiments of the present invention can perform associated bandwidth control to downlink data flows of one or multiple sub data flows by using the technical means of receiving a downlink shared bandwidth value of one or multiple sub data flows transmitted by a PCRF entity and performing bandwidth control to the downlink data flows of the one or multiple sub data flows according to the downlink shared bandwidth value by a PCEF entity or a BBERF entity, such that the downlink data flows of the one or multiple sub data flows make full use of the shared bandwidth, thereby solving a problem that the existing bandwidth control mechanism hinders efficient use of the bandwidth.

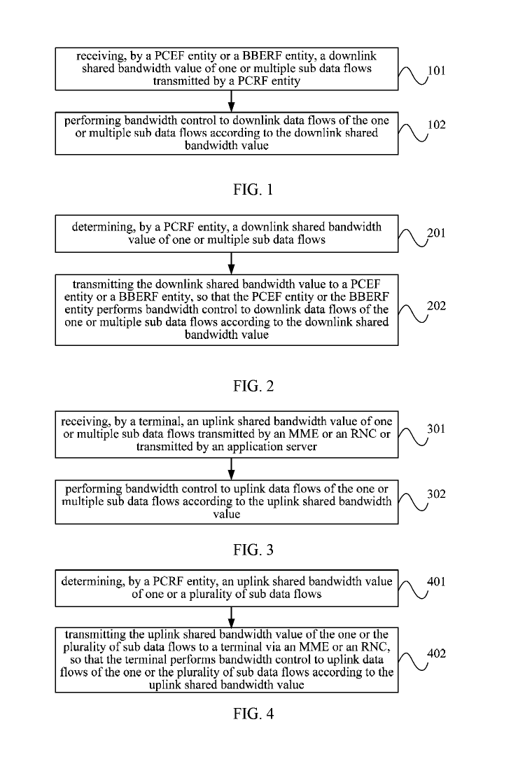

FIG. 2 is a schematic flow chart of a bandwidth control method according to another embodiment of the present invention. As shown in FIG. 2, the method includes:

201, determining, by a PCRF entity, a downlink shared bandwidth value of one or multiple sub data flows.

Specifically, the PCRF entity determines that a shared bandwidth control needs to be performed to one or multiple sub data flows according to an associated control strategy, and determines a downlink shared bandwidth value of the one or multiple sub data flows.

In applications, one or multiple sub data flows to which shared bandwidth control needs to be performed usually include the following cases:

1) one or multiple sub data flows belong to different sub applications of an application, e.g., sub applications such as QQ Video, QQ Speech and QQ Video belonging to the QQ application.

2) one or multiple sub data flows belong to a same application type, for example: different applications belonging to a P2P application type, such as BT download and Emule download; for another example: different applications belonging to an online video service, from the perspective of solving network transmission resources, it is unnecessary to simultaneously open multiple online video service applications for a real-time viewing, which will affect terminal experiences to some extent, and consume more network resources, therefore, it is necessary to perform an associated bandwidth control to data flows of different applications belonging to the online video service on the terminal.

3) based on an operator strategy such as charging or others, an associated bandwidth control needs to be performed to multiple data flows.

202, transmitting the downlink shared bandwidth value to a PCEF entity or a BBERF entity, so that the PCEF entity or the BBERF entity performs bandwidth control to downlink data flows of the one or multiple sub data flows according to the downlink shared bandwidth value.

In an LTE scenario, the PCEF entity is generally located in a PDN GW, and the BBERF entity is generally located in an SGW; in a 3G scenario, the PCEF entity is generally located in a GGSN, and the BBERF entity is generally located in an SGSN.

Generally, if the PDN GW and the SGW abide by a GTP, then in 101, the PCEF entity receives the downlink shared bandwidth value issued by the PCRF entity via a Gx interface, optionally, also receives a PCC rule issued by the PCRF entity via the Gx interface. Specifically, the downlink shared bandwidth value and/or the PCC rule may be carried in an IP-CAN session modification message.

If the PDN GW and the SGW abide by a PMIP protocol, then the BBERF entity receives the downlink shared bandwidth value issued by the PCRF entity via a Gxx interface, optionally, also receives a QoS rule issued by the PCRF entity via the Gxx interface. Specifically, the downlink shared bandwidth value and/or the QoS rule may be carried in a gateway control session modification message.

In further, the downlink shared bandwidth value in 202 may be transmitted to the PCEF entity or the BBERF entity in different forms and by being carried in different carriers by the PCRF entity.

In an optional embodiment of the present invention, 202 specifically includes:

transmitting an associated control rule to the PCEF entity or the BBERF entity, where the associated control rule includes flow description of the one or multiple sub data flows and the downlink shared bandwidth value.

In this scenario, the one or multiple sub data flows are all sub data flows corresponding to one or multiple application identifiers. It should be noted that, the bandwidth limit performed to a certain application or a certain type of application group by the PCEF entity is within a range of the IP-CAN session, and may be a treatment crossing different IP-CAN bearers.

Specifically, the associated control rule may include a rule identifier, description information of a data flow, and bandwidth information. The rule identifier is unique in the IP-CAN session, and an application identifier corresponding to a data flow may be used as the rule identifier; the description information of the data flow may be detected from a TDF entity, and may also come from an AF entity, a P-CSCF entity or other application servers; the bandwidth information represents a bandwidth limit of the data flow corresponding to the description information of the data flow, and is used to indicate the downlink shared bandwidth value, e.g., 2M bps.

Optionally, if flow description in the associated control rule is detected by the TDF entity, then before 202, the method also includes:

determining one or multiple application identifiers corresponding to the one or multiple sub data flows;

instructing the TDF entity to perform a traffic detection to data flows corresponding to the one or multiple application identifiers; and

receiving flow description of the one or multiple sub data flows returned by the TDF entity.

It should be noted that, what the TDF returns is the flow description of the data flows corresponding to the one or multiple application identifiers, where the flow description of the data flows corresponding to the one or multiple application identifiers covers flow description of all sub data flows corresponding to the one or multiple application identifiers.

In another optional embodiment of the present invention, 202 specifically includes:

transmitting enhanced PCC rules of each sub data flow in the multiple data flows to the PCEF entity, or transmitting enhanced QoS rules of each sub data flow in the multiple data flows to the BBERF entity, where the enhanced PCC rule of each sub data flow includes a PCC rule corresponding to the sub data flow and a monitoring key for shared bandwidth, and then the enhanced QoS rule of each sub data flow includes a QoS rule corresponding to the sub data flow and a monitoring key for shared bandwidth, so that the PCEF entity or the BBERF entity performs the bandwidth control to the downlink data flows of one or multiple sub data flows of which the enhanced PCC rule or the enhanced QoS rule includes the monitoring key for shared bandwidth according to the downlink shared bandwidth value corresponding to the monitoring key for shared bandwidth.

One of the functions of an existing single PCC rule lies in mapping one or multiple sub data flows having a same QCI and ARP value to a certain bearer. Thus, when different sub data flows (QQ video, QQ speech, QQ file) in the QQ application have different QCI and/or ARP requirements, different PCC rules need to be used to describe these sub data flows (QQ video, QQ speech, QQ file) separately. In order to better implement associated bandwidth control performed by the PCEF entity or the BBERF entity to sub data flows coming from different PCC rules, in embodiments of the present invention, a PCC rule of a sub data flow to which the associated bandwidth control needs to be performed is marked to form an enhanced PCC rule, specifically, a monitoring key for shared bandwidth is added in the original PCC rule, this monitoring key may be generated by the PCRF entity or acquired by the PCRF entity from other entities such as an HSS or an SPR entity. The PCRF entity uses this monitoring key to mark the sub data flow that needs bandwidth sharing, where this mark is transferred in all PCC rules corresponding to sub data flows that need to be associated. Certainly, the PCRF entity may also use different monitoring keys for bandwidth to mark different groups of sub data flows which need the bandwidth sharing respectively.

Optionally, the enhanced PCC rule or the enhanced QoS rule of at least one sub data flow in the multiple data flows also include the downlink shared bandwidth value corresponding to the monitoring key for shared bandwidth.

Specifically, the downlink shared bandwidth value is also newly added in the enhanced PCC rule or the enhanced QoS rule. Since the downlink shared bandwidth value is shared by one or multiple sub data flows, thus, as long as the downlink shared bandwidth value is carried in the enhanced PCC rule or the enhanced QoS rule of one of the sub data flows, it will be OK, while unnecessary to carry the downlink shared bandwidth value in the enhanced PCC rule or the enhanced QoS rule of each sub data flow. It should be noted that, in order to adapt to unceasing changes of a network policy, a time stamp may also be newly added in the enhanced PCC rule or the enhanced QoS rule, when downlink shared bandwidth values corresponding to a same monitoring key included in the enhanced PCC rules or the enhanced QoS rules of one or multiple sub data flows are different, then the one with the latest time stamp prevails.

Optionally, before 201, also including:

transmitting a key-bandwidth correlation table to the PCEF entity or the BBERF entity, where the key-bandwidth correlation table includes a corresponding relation between the monitoring key for shared bandwidth and the downlink shared bandwidth value, so that the PCEF entity or the BBERF entity determines the downlink shared bandwidth value corresponding to the monitoring key for shared bandwidth included in the enhanced PCC rules or the enhanced QoS rules according to the key-bandwidth correlation table.

Specifically, during a process of establishing or modifying an IP-CAN session, the PCRF entity transmits the first key-bandwidth correlation table to the PCEF entity, for instance: a monitoring key “key 1” corresponds to 2 Mbps, a monitoring key “key 2” corresponds to 4 Mbps, a monitoring key “key 3” corresponds to 6 Mbps, etc. Thus, in the enhanced PCC rule, only a monitoring key “key X” needs to be added, and the PCEF entity finds a downlink shared bandwidth value corresponding to key X in the first key-bandwidth correlation table, for instance, a monitoring key “key 2” is included in the enhanced PCC rule, then the PCEF entity determines that the corresponding downlink shared bandwidth value is 4 Mbps.

Optionally, the first key-bandwidth correlation table may also be predefined. For instance, it is predefined that key 2.0 represents that a downlink shared bandwidth value is 2.0 Mbps, and key 200 represents that a downlink shared bandwidth value is 200 Mbps.

Embodiments of the present invention can perform associated bandwidth control to downlink data flows of one or multiple sub data flows by using the technical means of transmitting a downlink shared bandwidth value of one or multiple sub data flows to a PCEF entity or a BBERF entity by a PCRF entity so that the PCEF entity or the BBERF entity performs bandwidth control to the downlink data flows of the one or multiple sub data flows according to the downlink shared bandwidth value, such that the downlink data flows of the one or multiple sub data flows make full use of the shared bandwidth, thereby solving a problem that the existing bandwidth control mechanism hinders efficient use of the bandwidth.

FIG. 3 is a schematic flow chart of a bandwidth control method according to still another embodiment of the present invention. As shown in FIG. 3, the method includes:

301, receiving, by a terminal, an uplink shared bandwidth value of one or multiple sub data flows transmitted by a mobility management entity (MME for short) or a radio network controller (RNC for short) or transmitted by an application server.

The application server herein may be an ANDSF. Specifically, the MME or the RNC may transmit the uplink shared bandwidth value to the terminal via a base station.

302, performing bandwidth control to uplink data flows of the one or multiple sub data flows according to the uplink shared bandwidth value.

Specifically, the performing the bandwidth control to the uplink data flows of the one or multiple sub data flows according to the uplink shared bandwidth value may be controlling total bandwidth of the uplink data flows of the one or multiple sub data flows within a range of the uplink shared bandwidth value. For instance, the one or multiple sub data flows include QQ Video sub data flows, QQ Speech sub data flows and QQ File sub data flows under QQ applications, the uplink shared bandwidth value is 2M bps, then control total bandwidth of uplink data flows of the QQ Video sub data flows, the QQ Speech sub data flows and the QQ File sub data flows not to exceed 2M bps.

In an optional embodiment of the present invention, the one or multiple sub data flows are all sub data flows corresponding to one or multiple application identifiers; 301 specifically includes:

receiving, by the terminal, the one or multiple application identifiers and the uplink shared bandwidth value transmitted by the MME or the RNC or transmitted by the application server;

302 specifically includes:

performing the bandwidth control to the uplink data flows of all sub data flows corresponding to the one or multiple application identifiers according to the uplink shared bandwidth value.

Specifically, the terminal receives the one or multiple application identifiers and the uplink shared bandwidth value transmitted by the MME or the RNC during an attach process, a PDN connection establishment process or a bearer update process of the terminal. In further, in an LTE scenario, the MME may acquire the uplink shared bandwidth value from the PCRF entity via an SGW and a PDN GW; in a 3G scenario, the RNC may acquire the uplink shared bandwidth value from the PCRF entity via an SGSN and a GGSN.

In another optional embodiment of the present invention, the one or multiple sub data flows correspond to one or multiple bearers; 301 specifically includes:

receiving, by the terminal, an enhanced traffic filter template (TFT for short) of the one or multiple bearers transmitted by the MME or the RNC, where the enhanced TFT of each bearer includes filter descriptions (filter information) of corresponding sub data flow, filter descriptions of the one or the multiple sub data flows include flow descriptions corresponding to the sub data flows and a monitoring key for shared bandwidth respectively;

302 specifically includes:

determining an uplink shared bandwidth value corresponding to the monitoring key for shared bandwidth; and

performing bandwidth control to the uplink data flows of the one or the multiple sub data flows of which the filter description includes the monitoring key for shared bandwidth according to the uplink shared bandwidth value.

Optionally, the filter descriptions of at least one sub data flow in the multiple data flows also include the uplink shared bandwidth value;

the determining the uplink shared bandwidth value corresponding to the monitoring key for shared bandwidth specifically includes:

determining the uplink shared bandwidth value included in the filter description of the at least one sub data flow as an uplink shared bandwidth value corresponding to the monitoring key for shared bandwidth included in the filter descriptions of the at least one sub data flow.

Optionally, before 301, the method also includes:

receiving, by the terminal, a second key-bandwidth correlation table transmitted by the MME or the RNC, where the second key-bandwidth correlation table includes a corresponding relation between the monitoring key for shared bandwidth and the uplink shared bandwidth value;

the determining the uplink shared bandwidth value corresponding to the monitoring key for shared bandwidth specifically includes:

determining the uplink shared bandwidth value corresponding to the monitoring key for shared bandwidth according to the second key-bandwidth correlation table.

In further, the receiving, by the terminal, the enhanced TFT of the one or multiple bearers transmitted by the MME or the RNC specifically includes:

receiving, by the terminal, the enhanced TFT of the one or multiple bearers transmitted by the MME or the RNC during a bearer update process of the terminal.

In further, the receiving the second key-bandwidth correlation table transmitted by the MME or the RNC specifically includes:

receiving, by the terminal, the second key-bandwidth correlation table transmitted by the MME or the RNC during an attach process of the terminal.

In embodiments of the present invention, a terminal can perform associated bandwidth control to uplink data flows of one or multiple sub data flows by using the technical means of receiving an uplink shared bandwidth value of one or multiple sub data flows transmitted by an MME or an RNC or transmitted by application server and performing bandwidth control to the uplink data flows of the one or multiple sub data flows according to the uplink shared bandwidth value by the terminal, such that the one or multiple sub data flows in the uplink direction of the terminal make full use of the shared bandwidth, thereby solving a problem that the existing bandwidth control mechanism hinders efficient use of the bandwidth.

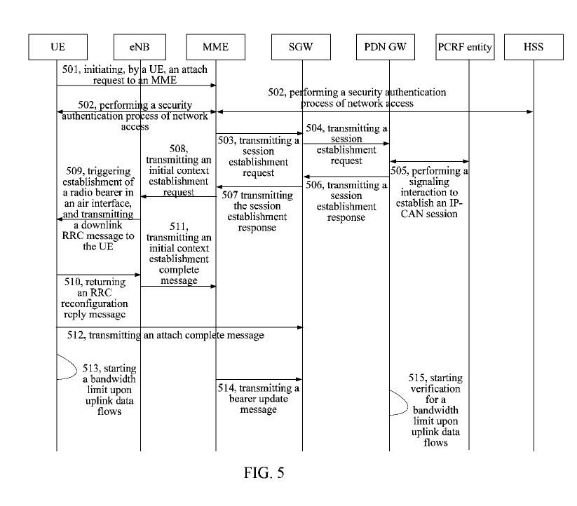

FIG. 4 is a schematic flow chart of another bandwidth control method according to an embodiment of the present invention. As shown in FIG. 4, the method includes:

401, determining, by a PCRF entity, an uplink shared bandwidth value of one or multiple sub data flows.

402, transmitting the uplink shared bandwidth value of the one or multiple sub data flows to a terminal via an MME or an RNC, so that the terminal performs bandwidth control to uplink data flows of the one or multiple sub data flows according to the uplink shared bandwidth value.

In an optional embodiment of the present invention, the one or multiple sub data flows are all sub data flows corresponding to one or multiple application identifiers; 402 specifically includes:

transmitting the one or multiple application identifiers and the uplink shared bandwidth value to the terminal via the MME or the RNC.

Specifically, the one or multiple application identifiers and the uplink shared bandwidth value may be transmitted to the terminal via the MME or the RNC during an attach process, a PDN connection establishment process or a bearer update process of the terminal.

In further, it may also be detected from a network side whether the terminal performs associated bandwidth processing to the uplink data flows of the one or multiple sub data flows. Correspondingly, after the transmitting the one or the multiple application identifiers and the uplink shared bandwidth value to the terminal via the MME or the RNC, the method also includes:

transmitting the one or multiple application identifiers and the uplink shared bandwidth value to a gateway, so that the gateway performs bandwidth detection and shaping to the uplink data flows of the one or multiple sub data flows transmitted by the terminal according to the one or multiple application identifiers and the uplink shared bandwidth value.

The gateway herein may be specifically a PCEF entity, a BBERF entity, a broadband network gateway (BNG for short) or the like with a TDF which is located in a PDN GW or a GGSN.

In still another optional embodiment of the present invention, the one or multiple sub data flows correspond to one or multiple bearers; 402 specifically includes:

transmitting an enhanced TFT of the one or multiple bearers to the terminal via the MME or the RNC, where the enhanced TFT of each bearer include filter description of a corresponding sub data flow, filter descriptions of the one or multiple sub data flows include flow descriptions corresponding to the sub data flows and a monitoring key for shared bandwidth respectively, so that the terminal determines an uplink shared bandwidth value corresponding to the monitoring key for shared bandwidth, and performs the bandwidth control according to the uplink shared bandwidth value to the uplink data flows of the one or multiple sub data flows of which the filter description includes the monitoring key for shared bandwidth.

Optionally, the transmitting the enhanced TFT of the one or the multiple bearers to the terminal via the MME or the RNC specifically includes:

adding the uplink shared bandwidth value to the filter descriptions of at least one sub data flow in the one or the multiple sub data flows, and transmitting the enhanced TFT of the one or multiple bearers to the terminal via the MME or the RNC, so that the terminal determines the uplink shared bandwidth value included in the filter description of the at least one sub data flow as an uplink shared bandwidth value corresponding to the monitoring key for shared bandwidth included in the filter description of the at least one sub data flows.

In further, the transmitting the enhanced TFT of the one or multiple bearers to the terminal via the MME or the RNC specifically includes:

transmitting the enhanced TFT of the one or the multiple bearers to the terminal via the MME or the RNC during an attach process or a bearer update process of the terminal.

Embodiments of the present invention can perform associated bandwidth control to one or multiple sub data flows in the uplink direction of a terminal by using the technical means of determining an uplink shared bandwidth value of one or multiple sub data flows and transmitting the uplink shared bandwidth value of the one or multiple sub data flows to the terminal via an MME or an RNC by a PCRF entity so that the terminal performs bandwidth control to the uplink data flows of the one or multiple sub data flows according to the uplink shared bandwidth value, such that the one or the multiple sub data flows in the uplink direction make full use of the shared bandwidth, thereby solving a problem that the existing bandwidth control mechanism hinders efficient use of the bandwidth.

FIG. 5 is a schematic diagram of a signaling according to the embodiment as shown in FIG. 3 and FIG. 4. As shown in FIG. 5, a signaling process in an LTE scenario includes:

501, initiating, by a terminal (UE), an attach request to an MME.

An access point (Access Point Name, APN for short) indication which needs to be requested may be carried in the attach request.

502, performing, by the MME, a security authentication process of network access to the terminal via an HSS.

Meanwhile, a security association of a non-access layer is activated.

503, transmitting, by the MME, a session establishment request to an SGW.

If, in 501, the attach request transmitted by the UE does not carry the APN indication, then the MME will carry a default APN indication in the session establishment request.

The MME creates a bearer identity ID for a PDN connection corresponding to the APN, and transmits the session establishment request to the SGW, where QoS and PDN addresses born by a default EPS are included in the request.

504, transmitting, by the SGW, the session establishment request to a PDN GW.

Meanwhile, the SGW adds an entry of an EPS bearer. The session establishment request in 504 points to the PDN address included in the session establishment request of 503.

505, if the network has PCC deployment, performing, by the PDN GW and a PCRF entity, a signaling interaction to establish an IP-CAN session.

The PDN GW acquires a QoS policy corresponding to the default EPS bearer from the PCRF entity so as to establish a default EPS bearer corresponding to the PDN. In this process, a QoS policy required for establishing a dedicated bearer may also be acquired. The QoS policy includes a QCI and an ARP of the bearer. The PDN GW acquires uplink bandwidth limit parameter of a certain application/a certain application group based on a terminal subscriber or a network policy from the PCRF entity, for example, the parameter format is application identifier (Application ID), and an uplink shared bandwidth value (bandwidth value) associated with the application.

It should be noted that, values (Application ID, bandwidth value) described in this embodiment may be associated with the APN, and may also not be associated with the APN.

506, transmitting, by the PDN GW, a session establishment response to the SGW.

Meanwhile, the PDN GW creates an entry in a table of EPS bearer context.

507, transmitting, by the SGW, the session establishment response to the MME.

The session establishment response also includes uplink bandwidth limit parameters (Application ID, bandwidth value) of a certain application or a certain application group based on the terminal subscriber or the network policy acquired by the PDN GW from the PCRF entity in 505.

508, transmitting, by the MME, an initial context establishment request to an eNB.

The initial context establishment request also includes uplink bandwidth limit parameters (Application ID, bandwidth value) of a certain application or a certain application group based on the terminal subscriber or the network policy acquired by the PDN GW from the PCRF entity in 505.

509, triggering, by the eNB, establishment of a radio bearer in an air interface, and transmitting a downlink radio resource control protocol (RRC for short) message to the UE.

The downlink RRC message carries uplink bandwidth limit parameters (Application ID, bandwidth value) of a certain application or a certain application group based on the terminal subscriber or the network policy.

510, returning, by the UE, an RRC reconfiguration reply message to the eNB.

511, transmitting, by the eNB, an initial context establishment complete message to the MME.

512, transmitting, by the UE, an attach complete message to the MME.

513, starting, by the UE, a bandwidth limit upon uplink data flows.

It should be noted that, 513 may occur before 511 or 512 as long as after 510, and sequences thereof are not limited.

514, transmitting, by the MME, a bearer update message to the SGW.

So far, the SGW can transmit the cached downlink data flows downwards.

It should be noted that, information (Application ID, bandwidth value) transferred in the above processes may be a group, i.e., uplink bandwidth limit information about a certain application or a certain application group, and may also be multi-groups information, i.e., values of a multi-groups application to which the uplink bandwidth control is performed.

515, starting, by the PDN GW, verification for a bandwidth limit upon uplink data flows.

When the PDN GW detects that bandwidth of uplink data flows regarding a certain application or a certain application group exceeds the bandwidth indicated by (Application ID, bandwidth value), the PDN GW will perform a further shaping to the data flows, for instance, discarding a part of service data flows.

It should be noted that, in a 3G scenario, the signaling process is similar to FIG. 5, except that the PDN GW is replaced with a GGSN, the SGW is replaced with an SGSN, and the MME is replaced with an RNC.

In the signaling process as shown in FIG. 5, a terminal may acquire all application-associated (Application ID, bandwidth value) control policies during an initial network access attach. Optionally, the terminal may also acquire (Application ID, bandwidth value) control policies regarding a certain application or a certain application group during subsequent PDN connection establishment processes; or acquire (Application ID, bandwidth value) regarding a certain application or a certain application group during subsequent bearer update processes; the (Application ID, bandwidth value) control policies stored on the terminal may also be updated during the PDN connection establishment or the bearer modifying process.

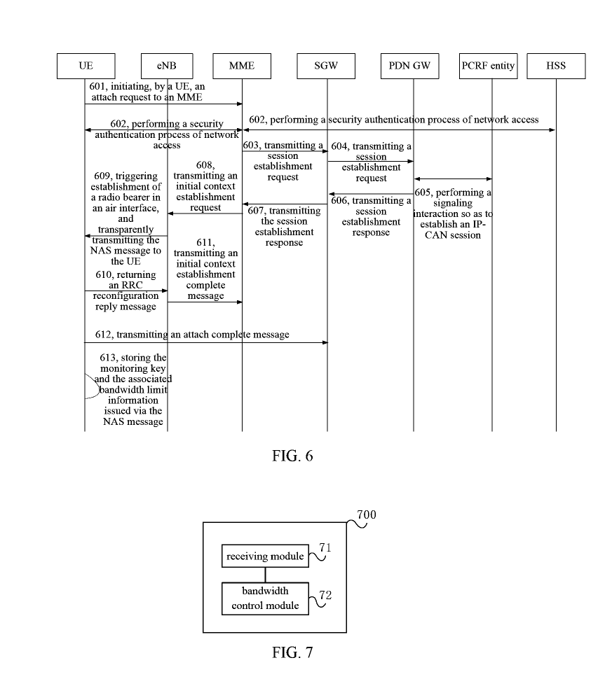

FIG. 6 is a schematic diagram of another signaling according to the embodiment as shown in FIG. 3 and FIG. 4. As shown in FIG. 6, the signaling process in an LTE scenario includes:

601, initiating, by a UE, an attach request to an MME.

An APN indication which needs to be requested may be carried in the attach request.

602, performing, by the MME, a security authentication process of network access to the terminal via an HSS.

Meanwhile, a security association of a non-access layer is activated. After the authentication succeeds, the MME acquires terminal subscriber information from the HSS. Optionally, the terminal subscriber information includes Monitoring key and associated bandwidth limit information, such as (Monitoring key 1, bandwidth A) and (Monitoring key 2, bandwidth B).

603, initiating, by the MME, a session establishment request to an SGW.

In 601, if the attach request transmitted by the UE does not carry the APN indication, then the MME will carry a default APN indication in the session establishment request.

604, transmitting, by the SGW, the session establishment request to a PDN GW.

Meanwhile, the SGW adds an entry of an EPS bearer. The session establishment request in 604 points to the PDN address included in the session establishment request of 603.
605, if the network has PCC deployment, performing, by the PDN GW, a signaling interaction to a PCRF entity so as to establish an IP-CAN session.

The PDN GW acquires a QoS policy corresponding to the default EPS bearer from the PCRF entity so as to establish a default EPS bearer corresponding to the PDN. In this process, a QoS policy required for establishing a dedicated bearer may also be acquired. The QoS policy includes a QCI and an ARP of the bearer.

606, transmitting, by the P-GW, a session establishment response to the SGW.

Meanwhile, the P-GW creates an entry in a table of EPS bearer context.

607, transmitting, by the SGW, the session establishment response to the MME.

608, transmitting, by the MME, an initial context establishment request to an eNB.

An initial context request message on an S1 interface carries an NAS message transmitted by the MME to the terminal. Specifically, the MME transparently transmits the network access service (NAS for short) message to the eNB, where the NAS message includes the Monitoring key and the associated bandwidth limit information which are acquired by the MME from the HSS in 602.

609, triggering, by the eNB, establishment of a radio bearer in an air interface, and transparently transmitting the NAS message to the UE.

610, returning, by the UE, an RRC reconfiguration reply message to the eNB.

611, transmitting, by the eNB, an initial context establishment complete message to the MME.

612, transmitting, by the UE, an attach complete message to the MME.

613, storing, by the UE, the monitoring key and the associated bandwidth limit information issued via the NAS message.

It should be noted that, 613 may be completed after 610. After 613, when the PCRF entity needs to perform uplink bandwidth associated control to a certain application or a certain group of applications of the terminal, the PCRF entity may trigger an update process of the EPS bearer so as to issue an enhanced TFT corresponding to the bearer to the UE. In this scenario, since the Monitoring key and the associated bandwidth limit information have been issued in the attach process as shown in FIG. 6, in the enhanced TFT issued by the PCRF entity to the UE, filter descriptions of each sub data flow may not include an uplink shared bandwidth value (i.e., the associated bandwidth limit information) corresponding to a monitoring key for bandwidth.

In a 3G scenario, the signaling process is similar to FIG. 6, except that the PDN GW is replaced with a GGSN, the SGW is replaced with an SGSN, and the MME is replaced with an RNC.

Persons of ordinary skill in the art may understand that, all or a part of the steps of the foregoing method embodiments may be implemented by a program instructing relevant hardware. The foregoing program may be stored in a computer readable storage medium. When the program runs, the steps of the foregoing method embodiments are performed. The foregoing storage medium includes various mediums capable of storing program codes, such as an ROM, an RAM, a magnetic disk, or an optical disc.

FIG. 7 is a schematic structural diagram of a bandwidth control device 700 according to an embodiment of the present invention. The device 700 is applied in a PCEF entity or a BBERF entity, as shown in FIG. 7, including:

a receiving module 71, configured to receive a downlink shared bandwidth value of one or multiple sub data flows transmitted by a PCRF entity; and

a bandwidth control module 72, configured to perform bandwidth control to downlink data flows of the one or multiple sub data flows according to the downlink shared bandwidth value.

Optionally, the receiving module 71 is specifically configured to receive an associated control rule transmitted by the PCRF entity, where the associated control rule includes a flow description of the one or multiple sub data flows and the downlink shared bandwidth value;

the bandwidth control module 72 specifically includes:

an acquiring unit, configured to acquire the flow description and the downlink shared bandwidth value from the associated control rule; and

a first control unit, configured to perform the bandwidth control to the downlink data flows of the one or multiple sub data flows corresponding to the flow descriptions according to the downlink shared bandwidth value.

Optionally, when the device is applied in the PCEF entity, the receiving module 71 is specifically configured to receive an enhanced PCC rule of each sub data flow in the one or multiple sub data flows transmitted by the PCRF entity, and the enhanced PCC rule of each sub data flow include a PCC rule of the corresponding sub data flow and a monitoring key for shared bandwidth; when the device is applied in the BBERF entity, the receiving module 71 is specifically configured to receive an enhanced QoS rule of each sub data flow in the one or multiple sub data flows transmitted by the PCRF entity, and the enhanced QoS rule of each sub data flow include a QoS rule of the corresponding sub data flow and a monitoring key for shared bandwidth;

the bandwidth control module 72 specifically includes:

a determining unit, configured to determine a downlink shared bandwidth value corresponding to the monitoring key for shared bandwidth; and

a second control unit, configured to perform the bandwidth control to the downlink data flows of the one or multiple sub data flows of which the enhanced PCC rule or the enhanced QoS rule includes the monitoring key for shared bandwidth according to the downlink shared bandwidth value.

In further, the enhanced PCC rule or the enhanced QoS rule of at least one sub data flow in the one or multiple sub data flows also include the downlink shared bandwidth value;

the determining unit is specifically configured to determine the downlink shared bandwidth value included in a filter description of the at least one sub data flow as a downlink shared bandwidth value corresponding to the monitoring key for shared bandwidth included in the enhanced PCC rule or the enhanced QoS rule of the at least one sub data flow.

Optionally, the receiving module 71 is also configured to receive a first key-bandwidth correlation table transmitted by the PCRF entity, where the first key-bandwidth correlation table includes a corresponding relation between the monitoring key for shared bandwidth and the downlink shared bandwidth value;

the determining unit is specifically configured to determine the downlink shared bandwidth value corresponding to the monitoring key for shared bandwidth according to the first key-bandwidth correlation table.

For implementations of this embodiment, reference may be made to a bandwidth control method provided by embodiments of the present invention as shown in FIG. 1. Embodiments of the present invention can perform associated bandwidth control to one or multiple sub data flows in the downlink direction by using the technical means of receiving a downlink shared bandwidth value of one or multiple sub data flows transmitted by a PCRF entity and performing bandwidth control to the downlink data flows of the one or multiple sub data flows according to the downlink shared bandwidth value by a PCEF entity or a BBERF entity, such that the one or multiple sub data flows in the downlink direction make full use of the shared bandwidth, thereby solving a problem that the existing bandwidth control mechanism hinders efficient use of the bandwidth.

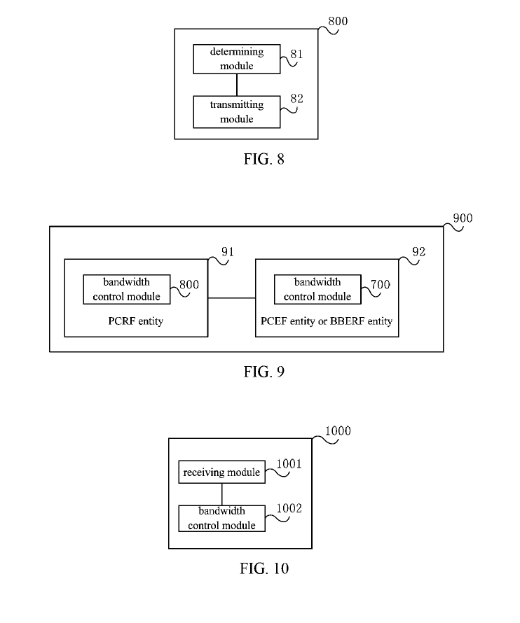

FIG. 8 is a schematic structural diagram of a bandwidth control device 800 according to another embodiment of the present invention. The device 800 is applied in a PCRF entity, as shown in FIG. 8, including:

a determining module 81, configured to determine a downlink shared bandwidth value of one or multiple sub data flows; and

a transmitting module 82, configured to transmit the downlink shared bandwidth value to a PCEF entity or a BBERF entity, to enable the PCEF entity or the BBERF entity to perform bandwidth control to downlink data flows of the one or multiple sub data flows according to the downlink shared bandwidth value.

Optionally, the transmitting module 82 is specifically configured to transmit an associated control rule to the PCEF entity or the BBERF entity, where the associated control rule includes a flow description of the one or multiple sub data flows and the downlink shared bandwidth value.

Optionally, the transmitting module 82 is specifically configured to transmit an enhanced PCC rule of each sub data flow in of the multiple data flows to the PCEF entity, or transmit an enhanced QoS rule of each sub data flow in the multiple data flows to the BBERF entity, where the enhanced PCC rule of each sub data flow include a PCC rule of the corresponding sub data flow and a monitoring key for shared bandwidth, and the enhanced QoS rule of each sub data flow include a QoS rule of the corresponding sub data flow and a monitoring key for shared bandwidth, to enable the PCEF entity or the BBERF entity to perform the bandwidth control to the downlink data flows of the one or multiple sub data flows of which the enhanced PCC rule or the enhanced QoS rule includes the monitoring key for shared bandwidth according to the downlink shared bandwidth value corresponding to the monitoring key for shared bandwidth.

In further, the enhanced PCC rule or the enhanced QoS rule of at least one sub data flow in the multiple data flows also includes the downlink shared bandwidth value corresponding to the monitoring key for shared bandwidth.

Optionally, the transmitting module 82 is also configured to transmit a key-bandwidth correlation table to the PCEF entity or the BBERF entity, where the key-bandwidth correlation table includes a corresponding relation between the monitoring key for shared bandwidth and the downlink shared bandwidth value, to enable the PCEF entity or the BBERF entity to determine the downlink shared bandwidth value corresponding to the monitoring key for shared bandwidth included in the enhanced PCC rule or the enhanced QoS rule according to the key-bandwidth correlation table.

Optionally, the one or multiple sub data flows are all sub data flows corresponding to one or multiple application identifiers; the device 800 also includes:

an instruction detecting module, configured to: before the transmitting the downlink shared bandwidth value to the PCEF entity or the BBERF entity by the transmitting module 82, determine one or multiple application identifiers corresponding to the one or multiple the sub data flows; instruct a TDF entity to perform a traffic detection to data flows corresponding to the one or multiple application identifiers; and receive a flow description of the one or multiple sub data flows returned by the TDF entity.

Optionally, the device 800 also includes:

a receiving module, configured to receive a flow description of the one or multiple sub data flows transmitted by an AF server or a P-CSCF server.

For implementations of this embodiment, reference may be made to another bandwidth control method provided by embodiments of the present invention as shown in FIG. 2. Embodiments of the present invention can perform associated bandwidth control to one or multiple sub data flows in the downlink direction by using the technical means of transmitting a downlink shared bandwidth value of one or multiple sub data flows to a PCEF entity or a BBERF entity by a PCRF entity so that the PCEF entity or the BBERF entity performs bandwidth control to the downlink data flows of the one or multiple sub data flows according to the downlink shared bandwidth value, such that the one or the multiple sub data flows in the downlink direction make full use of the shared bandwidth, thereby solving a problem that the existing bandwidth control mechanism hinders efficient use of the bandwidth.

FIG. 9 is a schematic structural diagram of a bandwidth control system 900 according to an embodiment of the present invention. As shown in FIG. 9, the system 900 includes:

a PCRF entity 91, and a PCEF entity or a BBERF entity 92;

the PCRF entity 91 includes a bandwidth control device 800;

the PCEF entity or the BBERF entity includes a bandwidth control device 700.

Embodiments of the present invention can perform associated bandwidth control to one or multiple sub data flows in the downlink direction by using the technical means of transmitting a downlink shared bandwidth value of one or multiple sub data flows to a PCEF entity or a BBERF entity by a PCRF entity so that the PCEF entity or the BBERF entity performs bandwidth control to the downlink data flows of the one or multiple sub data flows according to the downlink shared bandwidth value, such that the one or the multiple sub data flows in the downlink direction make full use of the shared bandwidth, thereby solving a problem that the existing bandwidth control mechanism hinders efficient use of the bandwidth.

FIG. 10 is a schematic structural diagram of a bandwidth control device 1000 according to still another embodiment of the present invention. The device 1000 is applied in a terminal, including:

a receiving module 1001, configured to receive an uplink shared bandwidth value of one or multiple sub data flows transmitted by an MME or an RNC or transmitted by an application server; and

a bandwidth control module 1002, configured to perform bandwidth control to uplink data flows of the one or multiple sub data flows according to the uplink shared bandwidth value.

Optionally, the one or multiple sub data flows are all sub data flows corresponding to one or multiple application identifiers;

the receiving module 1001 is specifically configured to receive the one or multiple application identifiers and the uplink shared bandwidth value transmitted by the MME or the RNC or the application server;

the bandwidth control module 1002 is specifically configured to perform the bandwidth control to the uplink data flows of all sub data flows corresponding to the one or multiple application identifiers according to the uplink shared bandwidth value.

Optionally, the one or the multiple sub data flows correspond to one or multiple bearers;

the receiving module 1001 is specifically configured to receive an enhanced traffic filter template TFT of the one or multiple bearers transmitted by the MME or the RNC, where the enhanced TFT of each bearer includes a filter description of corresponding sub data flows, a filter description of the one or multiple sub data flows include a flow description of the corresponding sub data flow and a monitoring key for shared bandwidth respectively;

the bandwidth control module 1002 specifically includes:

a determining unit, configured to determine an uplink shared bandwidth value corresponding to the monitoring key for shared bandwidth; and

a control unit, configured to perform the bandwidth control to the uplink data flows of the one or multiple sub data flows of the monitoring key for shared bandwidth included in the filter description according to the uplink shared bandwidth value.

In further, the filter description of at least one sub data flow in multiple data flows also include the uplink shared bandwidth value;

the determining unit is specifically configured to determine the uplink shared bandwidth value included in the filter description of the at least one sub data flow as an uplink shared bandwidth value corresponding to the monitoring key for shared bandwidth included in the filter description of the at least one sub data flow.

Optionally, the receiving module 1001 is also configured to receive a second key-bandwidth correlation table transmitted by the MME or the RNC, where the second key-bandwidth correlation table includes a corresponding relation between the monitoring key for shared bandwidth and the uplink shared bandwidth value;

the determining unit is specifically configured to determine the uplink shared bandwidth value corresponding to the monitoring key for shared bandwidth according to the second key-bandwidth correlation table.

In further, the receiving module 1001 is specifically configured to receive the application identifiers and the uplink shared bandwidth value transmitted by the MME or the RNC during an attach process, a PDN connection establishment process or a bearer update process of the terminal.

In further, the receiving module 1001 is specifically configured to receive the enhanced TFT of the one or multiple bearers transmitted by the MME or the RNC during a bearer update process of the terminal.

Optionally, the receiving module 1001 is also specifically configured to receive the second key-bandwidth correlation table transmitted by the MME or the RNC during an attach process of the terminal.

For implementations of this embodiment, reference may be made to a bandwidth control method provided by still another embodiment of the present invention as shown in FIG. 3. Embodiments of the present invention can perform associated bandwidth control to one or multiple sub data flows in the uplink direction of a terminal by using the technical means of receiving an uplink shared bandwidth value of one or multiple sub data flows transmitted by an MME or an RNC via a base station or transmitted by an application server and performing bandwidth control to the uplink data flows of the one or multiple sub data flows according to the uplink shared bandwidth value by the terminal, such that the one or the multiple sub data flows in the uplink direction make full use of the shared bandwidth, thereby solving a problem that the existing bandwidth control mechanism hinders efficient use of the bandwidth.

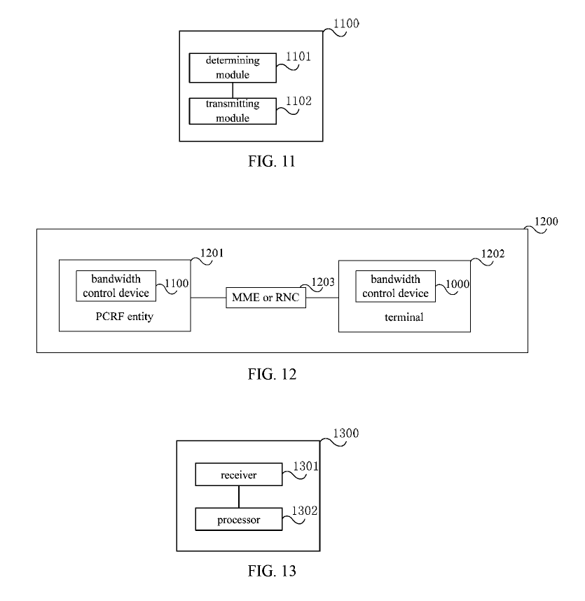

FIG. 11 is a schematic structural diagram of a bandwidth control device 1100 according to another embodiment of the present invention. The device 1100 is applied in a PCRF entity, including:

a determining module 1101, configured to determine an uplink shared bandwidth value of one or multiple sub data flows; and

a transmitting module 1102, configured to transmit the uplink shared bandwidth value of the one or multiple sub data flows to a terminal via an MME or an RNC, so that the terminal performs bandwidth control to uplink data flows of the one or multiple sub data flows according to the uplink shared bandwidth value.

Optionally, the one or multiple sub data flows are all sub data flows corresponding to one or multiple application identifiers;

the transmitting module 1102 is specifically configured to transmit the one or multiple application identifiers and the uplink shared bandwidth value to the terminal via the MME or the RNC.

Optionally, the one or multiple sub data flows correspond to one or multiple bearers;

the transmitting module 1102 is specifically configured to transmit an enhanced traffic filter template TFT of the one or multiple bearers to the terminal via the MME or the RNC, where the enhanced TFT of each bearer comprises a filter description of a corresponding sub data flow, a filter description of the one or multiple sub data flows comprise a flow description of the corresponding sub data flow and a monitoring key for shared bandwidth respectively, to enable the terminal to determine an uplink shared bandwidth value corresponding to the monitoring key for shared bandwidth, and perform the bandwidth control to the uplink data flows of the one or multiple sub data flows of which the filter description includes the monitoring key for shared bandwidth according to the uplink shared bandwidth value.

In further, the transmitting module 1102 is specifically configured to add the uplink shared bandwidth value to the filter description of at least one sub data flow in the one or multiple sub data flows, and transmit the enhanced TFT of the one or multiple bearers to the terminal via the MME or the RNC, to enable the terminal to determine the uplink shared bandwidth value included in the filter descriptions of the at least one sub data flow as an uplink shared bandwidth value corresponding to the monitoring key for shared bandwidth included in the filter description of the at least one sub data flow.

Optionally, the transmitting module 1102 is specifically configured to transmit the one or multiple application identifiers and the uplink shared bandwidth value to the terminal via the MME or the RNC during an attach process, a PDN connection establishment process or a bearer update process of the terminal.

Optionally, the transmitting module 1102 is specifically configured to transmit the enhanced TFT of the one or multiple bearers to the terminal via the MME or the RNC during an attach process or a bearer update process of the terminal.

In further, the transmitting module 1102 is also configured to transmit the one or multiple application identifiers and the uplink shared bandwidth value to a gateway, to enable the gateway to perform bandwidth detection and shaping to the uplink data flows of the one or multiple sub data flows transmitted by the terminal according to the one or multiple application identifiers and the uplink shared bandwidth value.

For implementations of this embodiment, reference may be made to a bandwidth control method provided by still another embodiment of the present invention as shown in FIG. 4. Embodiments of the present invention can perform associated bandwidth control to one or multiple sub data flows in the uplink direction of a terminal by using the technical means of determining an uplink shared bandwidth value of one or multiple sub data flows and transmitting the uplink shared bandwidth value of the one or multiple sub data flows to the terminal via an MME or an RNC by a PCRF entity so that the terminal performs bandwidth control to the uplink data flows of the one or the multiple sub data flows according to the uplink shared bandwidth value, such that the one or the multiple sub data flows in the uplink direction make full use of the shared bandwidth, thereby solving a problem that the existing bandwidth control mechanism hinders efficient use of the bandwidth.

FIG. 12 is a schematic structural diagram of another bandwidth control system 1200 according to an embodiment of the present invention. As shown in FIG. 12, the system 1200 includes:

a PCRF entity 1201, a terminal 1202, and an MME or an RNC 1203;

the PCRF entity 1201 includes a bandwidth control device 1100;

the terminal 1202 includes a bandwidth control device 1000.

Embodiments of the present invention can perform associated bandwidth control to one or multiple sub data flows in the uplink direction of a terminal by using the technical means of determining an uplink shared bandwidth value of one or multiple sub data flows and transmitting the uplink shared bandwidth value of the one or multiple sub data flows to the terminal via an MME or an RNC by a PCRF entity so that the terminal performs bandwidth control to the uplink data flows of the one or multiple sub data flows according to the uplink shared bandwidth value, such that the one or multiple sub data flows in the uplink direction make full use of the shared bandwidth, thereby solving a problem that the existing bandwidth control mechanism hinders efficient use of the bandwidth.

FIG. 13 is a schematic structural diagram of a bandwidth control device 1300 according to still another embodiment of the present invention. As shown in FIG. 13, the device 1300 is applied in a policy and charging enforcement function PCEF entity or a bearing binding and event report function BBERF entity, including:

a receiver 1301, configured to receive a downlink shared bandwidth value of one or multiple sub data flows transmitted by a policy and charging rules function PCRF entity; and

a processor 1302, configured to perform bandwidth control to downlink data flows of the one or multiple sub data flows according to the downlink shared bandwidth value.

In further, the receiver 1301 is specifically configured to receive an associated control rule transmitted by the PCRF entity, where the associated control rule includes a flow description of the one or multiple sub data flows and the downlink shared bandwidth value;

the processor 1302 is specifically configured to:

acquire the flow description and the downlink shared bandwidth value from the associated control rule; and

perform the bandwidth control to the downlink data flows of the one or multiple sub data flows corresponding to the flow description according to the downlink shared bandwidth value.

Optionally, when the device is applied in the PCEF entity, the receiver 1301 is specifically configured to receive an enhanced policy and charging control PCC rule of each sub data flow in the one or multiple sub data flows transmitted by the PCRF entity, and the enhanced PCC rule of each sub data flow includes a PCC rule of the corresponding sub data flow and a monitoring key for shared bandwidth; when the device is applied in the BBERF entity, the receiver 1301 is specifically configured to receive an enhanced quality of service QoS rule of each sub data flow in the one or multiple sub data flows transmitted by the PCRF entity, and the enhanced QoS rule of each sub data flow includes a QoS rule of the corresponding sub data flow and a monitoring key for shared bandwidth;

the processor 1302 is specifically configured to:

determine a downlink shared bandwidth value corresponding to the monitoring key for shared bandwidth; and

perform the bandwidth control to the downlink data flows of the one or multiple sub data flows of which the enhanced PCC rule or the enhanced QoS rule includes the monitoring key for shared bandwidth according to the downlink shared bandwidth value.

In further, the enhanced PCC rule of at least one sub data flow in the one or multiple sub data flows also include the downlink shared bandwidth value;

the processor 1302 is specifically configured to determine the downlink shared bandwidth value included in a filter description of the at least one sub data flow as a downlink shared bandwidth value corresponding to the monitoring key for shared bandwidth included in the enhanced PCC rule or the enhanced QoS rule of the at least one sub data flow.

Optionally, the receiver 1301 is also configured to receive a first key-bandwidth correlation table transmitted by the PCRF entity, where the first key-bandwidth correlation table includes a corresponding relation between the monitoring key for shared bandwidth and the downlink shared bandwidth value;

the processor 1302 is specifically configured to determine the downlink shared bandwidth value corresponding to the monitoring key for shared bandwidth according to the first key-bandwidth correlation table.

For implementations of this embodiment, reference may be made to a bandwidth control method provided by embodiments of the present invention as shown in FIG. 1. Embodiments of the present invention can perform associated bandwidth control to one or multiple sub data flows in the downlink direction by using the technical means of receiving a downlink shared bandwidth value of one or multiple sub data flows transmitted by a PCRF entity and performing bandwidth control to the downlink data flows of the one or multiple sub data flows according to the downlink shared bandwidth value by a PCEF entity or a BBERF entity, such that the one or the multiple sub data flows in the downlink direction make full use of the shared bandwidth, thereby solving a problem that the existing bandwidth control mechanism hinders efficient use of the bandwidth.

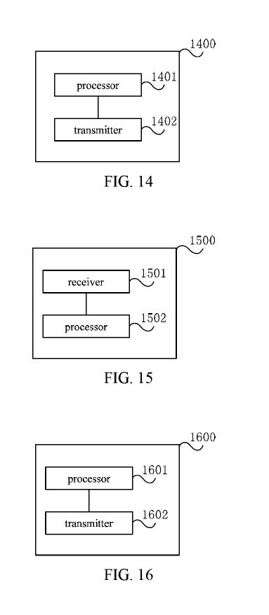

FIG. 14 is a schematic structural diagram of a bandwidth control device 1400 according to still another embodiment of the present invention. As shown in FIG. 14, the device 1400 is applied in a policy and charging rules function PCRF entity, including:

a processor 1401, configured to determine a downlink shared bandwidth value of one or multiple sub data flows; and

a transmitter 1402, configured to transmit the downlink shared bandwidth value to a policy and charging enforcement function PCEF entity or a bearing binding and event report function BBERF entity, to enable the PCEF entity or the BBERF entity to perform bandwidth control to downlink data flows of the one or multiple sub data flows according to the downlink shared bandwidth value.

In further, the transmitter 1402 is specifically configured to transmit an associated control rule to the PCEF entity or the BBERF entity, where the associated control rule includes a flow description of the one or multiple sub data flows and the downlink shared bandwidth value.

Optionally, the transmitter 1402 is specifically configured to transmit an enhanced policy and charging control PCC rule of each sub data flow in the multiple data flows to the PCEF entity, or transmit an enhanced quality of service QoS rule of each sub data flow in the multiple data flows to the BBERF entity, where the enhanced PCC rule of each sub data flow include a PCC rule of the corresponding sub data flow and a monitoring key for shared bandwidth, and the enhanced QoS rule of each sub data flow include a QoS rule of the corresponding sub data flow and a monitoring key for shared bandwidth, to enable the PCEF entity or the BBERF entity to perform the bandwidth control to the downlink data flows of the one or multiple sub data flows of which the enhanced PCC rule or the enhanced QoS rule includes the monitoring key for shared bandwidth according to the downlink shared bandwidth value corresponding to the monitoring key for shared bandwidth.

In further, the enhanced PCC rule or the enhanced QoS rule of at least one sub data flow in the multiple data flows also includes the downlink shared bandwidth value corresponding to the monitoring key for shared bandwidth.

Optionally, the transmitter 1402 is also configured to transmit a key-bandwidth correlation table to the PCEF entity or the BBERF entity, where the key-bandwidth correlation table includes a corresponding relation between the monitoring key for shared bandwidth and the downlink shared bandwidth value, to enable the PCEF entity or the BBERF entity to determine the downlink shared bandwidth value corresponding to the monitoring key for shared bandwidth included in the enhanced PCC rule or the enhanced QoS rule according to the key-bandwidth correlation table.

Optionally, the one or multiple sub data flows are all sub data flows corresponding to one or multiple application identifiers; the processor 1402 is also configured to: before the transmitting the downlink shared bandwidth value to the policy and charging enforcement function PCEF entity or the bearing binding and event report function BBERF entity by the transmitter, determine one or multiple application identifiers corresponding to the one or multiple the sub data flows;

the transmitter 1401 is also configured to instruct a traffic detection function TDF entity to perform a traffic detection to data flows corresponding to the one or multiple application identifiers;

the device 1400 also includes: a first receiver, configured to receive a flow description of the one or multiple sub data flows returned by the TDF entity.

Optionally, the device 1400 also includes:

a second receiver, configured to receive flow descriptions of the one or multiple sub data flows transmitted by an application function AF server or a proxy-call session control function P-CSCF server.

For implementations of this embodiment, reference may be made to a bandwidth control method provided by another embodiment of the present invention as shown in FIG. 2. Embodiments of the present invention can perform associated bandwidth control to one or multiple sub data flows in the downlink direction by using the technical means of transmitting a downlink shared bandwidth value of one or multiple sub data flows to a PCEF entity or a BBERF entity by a PCRF entity so that the PCEF entity or the BBERF entity performs bandwidth control to the downlink data flows of the one or multiple sub data flows according to the downlink shared bandwidth value, such that the one or multiple sub data flows in the downlink direction make full use of the shared bandwidth, thereby solving a problem that the existing bandwidth control mechanism hinders efficient use of the bandwidth.

FIG. 15 is a schematic structural diagram of a bandwidth control device 1500 according to still another embodiment of the present invention. As shown in FIG. 15, the device 1500 is applied in a terminal, including:

a receiver 1501, configured to receive an uplink shared bandwidth value of one or multiple sub data flows transmitted by a mobility management entity MME or a radio network controller RNC or transmitted by an application server; and

a processor 1502, configured to perform bandwidth control to uplink data flows of the one or multiple sub data flows according to the uplink shared bandwidth value.

In further, the one or the multiple sub data flows are all sub data flows corresponding to one or multiple application identifiers;

the receiver 1501 is specifically configured to receive the one or multiple application identifiers and the uplink shared bandwidth value transmitted by the MME or the RNC or the application server;

the processor 1502 is specifically configured to perform the bandwidth control to the uplink data flows of all sub data flows corresponding to the one or multiple application identifiers according to the uplink shared bandwidth value.

Optionally, the one or the multiple sub data flows correspond to one or multiple bearers;

the receiver 1501 is specifically configured to receive an enhanced traffic filter template TFT of the one or multiple bearers transmitted by the MME or the RNC, where the enhanced TFT of each bearer includes a filter description of corresponding sub data flows, a filter description of the one or multiple sub data flows includes a flow description of the corresponding sub data flow and a monitoring key for shared bandwidth respectively;

the processor 1502 is specifically configured to:

determine an uplink shared bandwidth value corresponding to the monitoring key for shared bandwidth; and

perform the bandwidth control to the uplink data flows of the one or multiple sub data flows of the monitoring key for shared bandwidth included in the filter description according to the uplink shared bandwidth value.

In further, the filter descriptions of at least one sub data flow in the multiple data flows also include the uplink shared bandwidth value;

the processor 1502 is specifically configured to determine the uplink shared bandwidth value included in the filter description of the at least one sub data flow as an uplink shared bandwidth value corresponding to the monitoring key for shared bandwidth included in the filter description of the at least one sub data flow.

Optionally, the receiver 1501 is also configured to receive a second key-bandwidth correlation table transmitted by the MME or the RNC, where the second key-bandwidth correlation table includes a corresponding relation between the monitoring key for shared bandwidth and the uplink shared bandwidth value;

the processor 1502 is specifically configured to determine the uplink shared bandwidth value corresponding to the monitoring key for shared bandwidth according to the second key-bandwidth correlation table.

Optionally, the receiver 1501 is specifically configured to receive the one or multiple application identifiers and the uplink shared bandwidth value transmitted by the MME or the RNC during an attach process, a packet data network PDN connection establishment process or a bearer update process of the terminal.

Optionally, the receiver 1501 is specifically configured to receive the enhanced TFT of the one or multiple bearers transmitted by the MME or the RNC during a bearer update process of the terminal.

Optionally, the receiver 1501 is specifically configured to receive the second key-bandwidth correlation table transmitted by the MME or the RNC during an attach process of the terminal.

For implementations of this embodiment, reference may be made to a bandwidth control method provided by still another embodiment of the present invention as shown in FIG. 3. Embodiments of the present invention can perform associated bandwidth control to one or multiple sub data flows in the uplink direction of a terminal by using the technical means of receiving an uplink shared bandwidth value of one or multiple sub data flows transmitted by an MME or an RNC via a base station or transmitted by an application server and performing bandwidth control to the uplink data flows of the one or multiple sub data flows according to the uplink shared bandwidth value by the terminal, such that the one or multiple sub data flows in the uplink direction make full use of the shared bandwidth, thereby solving a problem that the existing bandwidth control mechanism hinders efficient use of the bandwidth.

FIG. 16 is a schematic structural diagram of a bandwidth control device 1600 according to still another embodiment of the present invention. As shown in FIG. 16, the device 1600 is applied in a policy and charging rules function PCRF entity, including:

a processor 1601, configured to determine an uplink shared bandwidth value of one or multiple sub data flows; and

a transmitter 1602, configured to transmit the uplink shared bandwidth value of the one or multiple sub data flows to a terminal via a mobility management entity MME or a radio network controller RNC, to enable the terminal to perform bandwidth control to uplink data flows of the one or multiple sub data flows according to the uplink shared bandwidth value.

In further, the one or multiple sub data flows are all sub data flows corresponding to one or multiple application identifiers; the transmitter 1602 is specifically configured to transmit the one or multiple application identifiers and the uplink shared bandwidth value to the terminal via the MME or the RNC.

Optionally, the one or multiple sub data flows correspond to one or multiple bearers; the transmitter 1602 is specifically configured to transmit an enhanced traffic filter template TFT of the one or multiple bearers to the terminal via the MME or the RNC, where the enhanced TFT of each bearer includes a filter description of a corresponding sub data flow, a filter description of the one or multiple sub data flows include a flow description of the corresponding sub data flows and a monitoring key for shared bandwidth respectively, to enable the terminal to determine an uplink shared bandwidth value corresponding to the monitoring key for shared bandwidth, and perform the bandwidth control to the uplink data flows of the one or multiple sub data flows of which the filter description includes the monitoring key for shared bandwidth according to the uplink shared bandwidth value.

In further, the transmitter 1602 is specifically configured to add the uplink shared bandwidth value to the filter description of at least one sub data flow in the one or multiple sub data flows, and transmit the enhanced TFT of the one or multiple bearers to the terminal via the MME or the RNC, to enable the terminal to determine the uplink shared bandwidth value included in the filter descriptions of the at least one sub data flow as an uplink shared bandwidth value corresponding to the monitoring key for shared bandwidth comprised in the filter description of the at least one sub data flow.

Optionally, the transmitter 1602 is specifically configured to transmit the one or multiple application identifiers and the uplink shared bandwidth value to the terminal via the MME or the RNC during an attach process, a packet data network PDN connection establishment process or a bearer update process of the terminal.

Optionally, the transmitter 1602 is specifically configured to transmit the enhanced TFT of the one or multiple bearers to the terminal via the MME or the RNC during an attach process or a bearer update process of the terminal.

Optionally, the transmitter 1602 is also configured to transmit the one or multiple application identifiers and the uplink shared bandwidth value to a gateway, to enable the gateway to perform bandwidth detection and shaping to the uplink data flows of the one or multiple sub data flows transmitted by the terminal according to the one or multiple application identifiers and the uplink shared bandwidth value.

For implementations of this embodiment, reference may be made to a bandwidth control method provided by still another embodiment of the present invention as shown in FIG. 4. Embodiments of the present invention can perform associated bandwidth control to one or multiple sub data flows in the uplink direction of a terminal by using the technical means of determining an uplink shared bandwidth value of one or multiple sub data flows and transmitting the uplink shared bandwidth value of the one or multiple sub data flows to the terminal via an MME or an RNC by a PCRF entity so that the terminal performs bandwidth control to the uplink data flows of the one or multiple sub data flows according to the uplink shared bandwidth value, such that the one or multiple sub data flows in the uplink direction make full use of the shared bandwidth, thereby solving a problem that the existing bandwidth control mechanism hinders efficient use of the bandwidth.

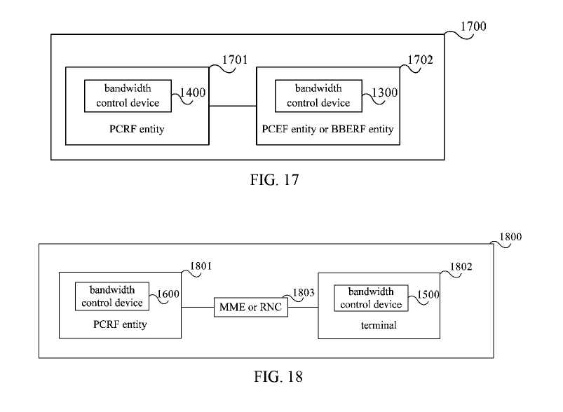

FIG. 17 is a schematic structural diagram of a bandwidth control system 1700 according to still another embodiment of the present invention. As shown in FIG. 17, the system 1700 includes: a PCRF entity 1701, and a PCEF entity or a BBERF entity 1702;

the PCRF entity 1701 includes a bandwidth control device 1400;

the PCEF entity or the BBERF entity 1702 includes a bandwidth control device 1300.

Embodiments of the present invention can perform associated bandwidth control to one or multiple sub data flows in the downlink direction by using the technical means of transmitting a downlink shared bandwidth value of one or multiple sub data flows to a PCEF entity or a BBERF entity by a PCRF entity so that the PCEF entity or the BBERF entity performs bandwidth control to the downlink data flows of the one or multiple sub data flows according to the downlink shared bandwidth value, such that the one or multiple sub data flows in the downlink direction make full use of the shared bandwidth, thereby solving a problem that the existing bandwidth control mechanism hinders efficient use of the bandwidth.

FIG. 18 is a schematic structural diagram of a bandwidth control system 1800 according to still another embodiment of the present invention. As shown in FIG. 18, the system 1800 includes: a PCRF entity 1801, a terminal 1802, and an MME or an RNC 1803;

the PCRF entity 1801 includes a bandwidth control device 1600;

the terminal 1802 includes a bandwidth control device 1500.

Embodiments of the present invention can perform associated bandwidth control to one or multiple sub data flows in the uplink direction of a terminal by means of using the technical means of determining an uplink shared bandwidth value of one or multiple sub data flows and transmitting the uplink shared bandwidth value of the one or multiple sub data flows to the terminal via an MME or an RNC by a PCRF entity so that the terminal performs bandwidth control to the uplink data flows of the one or multiple sub data flows according to the uplink shared bandwidth value, such that the one or multiple sub data flows in the uplink direction make full use of the shared bandwidth, thereby solving a problem that the existing bandwidth control mechanism hinders efficient use of the bandwidth.

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions described in the foregoing embodiments, or make equivalent replacements to some technical features thereof however, these modifications or replacements do not make the essence of corresponding technical solutions depart from the scope of the technical solutions in the embodiments of the present invention.

What is claimed is:

1. A bandwidth control method, comprising:
receiving, by a policy and charging enforcement function (PCEF) entity or a bearing binding and event report function (BBERF) entity, a downlink shared bandwidth value of one or multiple sub data flows transmitted by a policy and charging rules function (PCRF) entity; and
performing bandwidth control to downlink data flows of the one or multiple sub data flows according to the downlink shared bandwidth value.

2. The method according to claim 1, wherein, the receiving the downlink shared bandwidth value of the one or multiple sub data flows transmitted by the PCRF entity specifically comprises:
receiving an associated control rule transmitted by the PCRF entity, wherein the associated control rule comprises a flow description of the one or multiple sub data flows and the downlink shared bandwidth value;
the performing the bandwidth control to the downlink data flows of the one or multiple sub data flows according to the downlink shared bandwidth value specifically comprises:
acquiring the flow description and the downlink shared bandwidth value from the associated control rule; and
performing the bandwidth control to the downlink data flows of the one or multiple sub data flows corresponding to the flow description according to the downlink shared bandwidth value.

3. The method according to claim 1, wherein, the receiving, by the PCEF entity or the BBERF entity, the downlink shared bandwidth value of the one or multiple sub data flows transmitted by the PCRF entity specifically comprises:
receiving, by the PCEF entity, an enhanced policy and charging control (PCC) rule of each sub data flow in the one or multiple sub data flows transmitted by the PCRF entity, or receiving, by the BBERF entity, an enhanced quality of service (QoS) rule of each sub data flow in the one or multiple sub data flows transmitted by the PCRF entity, wherein the enhanced PCC rule of each sub data flow comprise a PCC rule of the corresponding sub data flow and a monitoring key for shared bandwidth, and the enhanced QoS rule of each sub data flow comprise a QoS rule of the corresponding sub data flow and a monitoring key for shared bandwidth;
the performing the bandwidth control to the downlink data flows of the one or multiple sub data flows according to the downlink shared bandwidth value specifically comprises:
determining a downlink shared bandwidth value corresponding to the monitoring key for shared bandwidth; and
performing the bandwidth control to the downlink data flows of the one or multiple sub data flows of which the enhanced PCC rule or the enhanced QoS rule comprises the monitoring key for shared bandwidth according to the downlink shared bandwidth value.

4. The method according to claim 3, wherein, the enhanced PCC rules or the enhanced QoS rules of at least one sub data flow in the one or multiple sub data flows also comprise the downlink shared bandwidth value;
the determining the downlink shared bandwidth value corresponding to the monitoring key for shared bandwidth specifically comprises:
determining the downlink shared bandwidth value comprised in a filter description of the at least one sub data flow as a downlink shared bandwidth value corresponding to the monitoring key for shared bandwidth comprised in the enhanced PCC rules or the enhanced QoS rules of the at least one sub data flow.

5. The method according to claim 3, wherein, before the receiving the downlink shared bandwidth value of the one or the multiple sub data flows transmitted by the PCRF entity, also comprising:
receiving a first key-bandwidth correlation table transmitted by the PCRF entity, wherein the first key-bandwidth correlation table comprises a corresponding relation between the monitoring key for shared bandwidth and the downlink shared bandwidth value;
the determining the downlink shared bandwidth value corresponding to the monitoring key for shared bandwidth specifically comprises:
determining the downlink shared bandwidth value corresponding to the monitoring key for shared bandwidth according to the first key-bandwidth correlation table.

6. A bandwidth control method, comprising:
receiving, by a terminal, an uplink shared bandwidth value of one or multiple sub data flows transmitted by a mobility management entity (MME) or a radio network controller (RNC) or transmitted by an application server; and
performing bandwidth control to uplink data flows of the one or multiple sub data flows according to the uplink shared bandwidth value.

7. The method according to claim 6, wherein, the one or multiple sub data flows are all sub data flows corresponding to one or multiple application identifiers; the receiving, by the terminal, the uplink shared bandwidth value of the one or multiple sub data flows transmitted by the MME or the RNC or transmitted by the application server specifically comprises:
receiving, by the terminal, the one or multiple application identifiers and the uplink shared bandwidth value transmitted by the MME or the RNC or the application server;
the performing, by the terminal, the bandwidth control to the uplink data flows of the one or multiple sub data flows according to the uplink shared bandwidth value specifically comprises:
performing the bandwidth control to the uplink data flows of all sub data flows corresponding to the one or multiple application identifications according to the uplink shared bandwidth value.

8. The method according to claim 6, wherein, the one or multiple sub data flows correspond to one or multiple bearers; the receiving, by the terminal, the uplink shared bandwidth value of the one or multiple sub data flows transmitted by the MME or the RNC specifically comprises:
receiving, by the terminal, an enhanced traffic filter template (TFT) of the one or multiple bearers transmitted by the MME or the RNC, wherein the enhanced TFT of each bearer comprises a filter description of corresponding sub data flow, a filter description of the one or the multiple sub data flows comprise a flow description of the corresponding sub data flow and a monitoring key for shared bandwidth respectively;
the performing the bandwidth control to the uplink data flows of the one or multiple sub data flows according to the uplink shared bandwidth value specifically comprises:
determining an uplink shared bandwidth value corresponding to the monitoring key for shared bandwidth; and
performing the bandwidth control to the uplink data flows of the one or multiple sub data flows of which the filter description comprises the monitoring key for shared bandwidth according to the uplink shared bandwidth value.

9. The method according to claim 8, wherein, the filter description of at least one sub data flow in the multiple data flows also comprise the uplink shared bandwidth value;
the determining the uplink shared bandwidth value corresponding to the monitoring key for shared bandwidth specifically comprises:
determining the uplink shared bandwidth value comprised in the filter description of the at least one sub data flow as an uplink shared bandwidth value corresponding to the monitoring key for shared bandwidth comprised in the filter description of the at least one sub data flow.

10. The method according to claim 8, wherein, before the receiving, by the terminal, the enhanced TFT of the one or multiple bearers transmitted by the MME or the RNC, also comprising:
receiving, by the terminal, a second key-bandwidth correlation table transmitted by the MME or the RNC, wherein the second key-bandwidth correlation table comprises a corresponding relation between the monitoring key for shared bandwidth and the uplink shared bandwidth value;
the determining the uplink shared bandwidth value corresponding to the monitoring key for shared bandwidth specifically comprises:
determining the uplink shared bandwidth value corresponding to the monitoring key for shared bandwidth according to the second key-bandwidth correlation table.

11. The method according to claim 7, wherein, the receiving, by the terminal, the one or multiple application identifiers and the uplink shared bandwidth value transmitted by the MME or the RNC specifically comprises:
receiving, by the terminal, the one or multiple application identifiers and the uplink shared bandwidth value transmitted by the MME or the RNC during an attach process, a packet data network (PDN) connection establishment process or a bearer update process of the terminal.

12. The method according to claim 8, wherein, the receiving, by the terminal, the enhanced TFT of the one or multiple bearers transmitted by the MME or the RNC specifically comprises:
receiving, by the terminal, the enhanced TFT of the one or multiple bearers transmitted by the MME or the RNC during a bearer update process of the terminal.

13. The method according to claim 10, wherein, the receiving the second key-bandwidth correlation table transmitted by the MME or the RNC specifically comprises:
receiving, by the terminal, the second key-bandwidth correlation table transmitted by the MME or the RNC during an attach process of the terminal.

14. A bandwidth control device, which is applied in a policy and charging enforcement function (PCEF) entity or a bearing binding and event report function (BBERF) entity, comprising:
a receiver, configured to receive a downlink shared bandwidth value of one or multiple sub data flows transmitted by a policy and charging rules function (PCRF) entity; and
a processor, configured to perform bandwidth control to downlink data flows of the one or multiple sub data flows according to the downlink shared bandwidth value.

15. The device according to claim 14, wherein, the receiver is specifically configured to receive an associated control rule transmitted by the PCRF entity, wherein the associated control rule comprises a flow description of the one or multiple sub data flows and the downlink shared bandwidth value;
the processor is specifically configured to:
acquire the flow descriptions and the downlink shared bandwidth value from the associated control rule; and
perform the bandwidth control to the downlink data flows of the one or multiple sub data flows corresponding to the flow description according to the downlink shared bandwidth value.

16. The device according to claim 14, wherein, when the device is applied in the PCEF entity, the receiver is specifically configured to receive an enhanced policy and charging control (PCC) rule of each sub data flow in the one or multiple sub data flows transmitted by the PCRF entity, and the enhanced PCC rule of each sub data flow comprises a PCC rule of the corresponding sub data flow and a monitoring key for shared bandwidth; when the device is applied in the BBERF entity, the receiver is specifically configured to receive an enhanced quality of service (QoS) rule of each sub data flow in the one or multiple sub data flows transmitted by the PCRF entity, and the enhanced QoS rule of each sub data flow comprises a QoS rule of the corresponding sub data flow and a monitoring key for shared bandwidth;
the processor is specifically configured to:
determine a downlink shared bandwidth value corresponding to the monitoring key for shared bandwidth; and
perform the bandwidth control to the downlink data flows of the one or multiple sub data flows of which the enhanced PCC rule or the enhanced QoS rule comprises the monitoring key for shared bandwidth according to the downlink shared bandwidth value.

17. The device according to claim 16, wherein, the enhanced PCC rule of at least one sub data flow in the one or multiple sub data flows also comprise the downlink shared bandwidth value;
the processor is specifically configured to determine the downlink shared bandwidth value comprised in a filter description of the at least one sub data flow as a downlink shared bandwidth value corresponding to the monitoring key for shared bandwidth comprised in the enhanced PCC rule or the enhanced QoS rule of the at least one sub data flow.

18. The device according to claim 16, wherein, the receiver is also configured to receive a first key-bandwidth correlation table transmitted by the PCRF entity, wherein the first key-bandwidth correlation table comprises a corresponding relation between the monitoring key for shared bandwidth and the downlink shared bandwidth value.
the processor is specifically configured to determine the downlink shared bandwidth value corresponding to the monitoring key for shared bandwidth according to the first key-bandwidth correlation table.

19. A bandwidth control device, which is applied in a terminal, comprising:
a receiver, configured to receive an uplink shared bandwidth value of one or multiple sub data flows transmitted by a mobility management entity (MME) or a radio network controller (RNC) or transmitted by an application server; and
a processor, configured to perform bandwidth control to uplink data flows of the one or multiple sub data flows according to the uplink shared bandwidth value.

20. The device according to claim 19, wherein, the one or multiple sub data flows are all sub data flows corresponding to one or multiple application identifiers;
the receiver is specifically configured to receive the one or multiple application identifiers and the uplink shared bandwidth value transmitted by the MME or the RNC or the application server;
the processor is specifically configured to perform the bandwidth control to the uplink data flows of all sub data flows corresponding to the one or multiple application identifiers according to the uplink shared bandwidth value.

21. The device according to claim 19, wherein, the one or multiple sub data flows correspond to one or multiple bearers;
the receiver is specifically configured to receive an enhanced traffic filter template (TFT) of the one or multiple bearers transmitted by the MME or the RNC, wherein the enhanced TFT of each bearer comprises a filter description of corresponding sub data flows, a filter description of the one or multiple sub data flows comprises a flow description of the corresponding sub data flow and a monitoring key for shared bandwidth respectively;
the processor is specifically configured to:
determine an uplink shared bandwidth value corresponding to the monitoring key for shared bandwidth; and
perform the bandwidth control to the uplink data flows of the one or multiple sub data flows of the monitoring key for shared bandwidth comprised in the filter description according to the uplink shared bandwidth value.

22. The device according to claim 21, wherein, the filter description of at least one sub data flow in the multiple data flows also comprise the uplink shared bandwidth value;
the processor is specifically configured to determine the uplink shared bandwidth value comprised in the filter description of the at least one sub data flow as an uplink shared bandwidth value corresponding to the monitoring key for shared bandwidth comprised in the filter description of the at least one sub data flow.

23. The device according to claim 21, wherein, the receiver is also configured to receive a second key-bandwidth correlation table transmitted by the MME or the RNC, wherein the second key-bandwidth correlation table comprises a corresponding relation between the monitoring key for shared bandwidth and the uplink shared bandwidth value;
the processor is specifically configured to determine the uplink shared bandwidth value corresponding to the monitoring key for shared bandwidth according to the second key-bandwidth correlation table.

24. The device according to claim 20, wherein, the receiver is specifically configured to receive the one or multiple application identifiers and the uplink shared bandwidth value transmitted by the MME or the RNC during an attach process, a packet data network (PDN) connection establishment process or a bearer update process of the terminal.

25. The device according to claim 21, wherein, the receiver is specifically configured to receive the enhanced TFT of the one or multiple bearers transmitted by the MME or the RNC during a bearer update process of the terminal.

26. The device according to claim 23, wherein, the receiver is specifically configured to receive the second key-bandwidth correlation table transmitted by the MME or the RNC during an attach process of the terminal.
